(19) United States
(12) Patent Application Publication
(10) Pub. No.: US 2010/0047420 A1
(43) Pub. Date: Feb. 25, 2010

(54) METHODS AND APPARATUS FOR MAKING A TEA CONCENTRATE

(75) Inventor: Ian Bersten, Roseville (AU)

Correspondence Address: Ballard Spahr LLP, SUITE 1000, 999 PEACHTREE STREET, ATLANTA, GA, 30309-3915, US

(73) Assignee: TEA-CHA TEAWARE PTY LIMITED, Chatswood (AU)

(21) Appl. No.: 12/312,272

(22) PCT Filed: Oct. 22, 2007
(86) PCT No.: PCT/AU2007/001600

§ 371 Date: Jun. 2, 2009

(30) Foreign Application Priority Data
Nov. 1, 2006 (AU) 2006906082
Feb. 20, 2007 (AU) 2007900854

(51) Int. Cl. A23F 3/34; A47J 31/18

(52) U.S. Cl. 426/435; 99/279; 99/323

(57) ABSTRACT

A method of making an individual serving of an aqueous tea concentrate comprises locating at a strainer a quantity of loose particulate tea material that is sufficient to produce the individual tea concentrate serving. The quantity of tea material is directly contacted with a sufficient amount of water so as to produce the individual tea concentrate serving. The particle size of the tea material, the tea material-water contact time and the temperature of the water can each be controlled so as to minimise the extract of tannins from the tea material and into the concentrate. The aqueous tea concentrate is collected once it has passed through the strainer to thereby separate it from the particulate tea material.

Apparatus and a kit for making the concentrate can comprise a strainer 34 at which a quantity of loose particulate tea material can be located for contact with water so as to produce an aqueous concentrate that is separated at the strainer from the tea material, and a mass 36, 36A that is locatable on the loose particulate tea material so as to restrain the upward expansion of the loose particulate tea material when it is directly contacted with the water.

### TECHNICAL FIELD

A method and apparatus for making a tea concentrate is disclosed. Also disclosed is a tea concentrate made by the method and a kit for implementing the method. The term “tea” as used herein includes the dried and/or prepared leaves of the plants of the Theaceae family (including the plant Camellia sinensis) but is also intended to include any kind of leaves, flowers etc., of other related or unrelated plants, species etc that can be dried and/or prepared for subsequent use in making a beverage concentrate.

### BACKGROUND ART

Tea beverage made from plants of the Theaceae family comprises a mixture of components in an aqueous solution that are extracted/leached from the dried or prepared leaves of such plants. The components include polyphenols, flavonoids, catechins and tannins (ref Journal of Chinese Medicine). Tannins are astringent and bitter-tasting plant polyphenols that bind and precipitate proteins, however, the term is more usually applied to any large polyphenolic compound containing sufficient hydroxyls and other suitable groups (such as carboxyls) to form strong complexes with proteins and other macromolecules. Catechins belong to the flavan-3-ol class of flavonoids. The four main catechins found in tea are gallocatechin, epigallocatechin, epicatechin, and epigallocatechin gallate. Research indicates that tea flavonoids have an antioxidant activity and are associated with tea's anti-carcinogenic, anti-inflammatory, anti-atherogenic, thermogenic and antimicrobial properties.

More specific components of tea include caffeine, theanine, theobromine and theophylline.

Caffeine is an odourless, slightly bitter-tasting alkaloid that can act as a mild stimulant to the nervous system, blocking the neurotransmitter adenosine and resulting in a feeling of well-being and alertness. It increases the heart rate, blood pressure, and urination and stimulates secretion of stomach acids. The amount of caffeine varies with the type of tea leaf, being higher with black and oolong teas, and lower with green and white teas.

Theanine is a non-protein amino acid mainly found naturally in the tea plant (Camellia sinensis). Theanine is a derivative of L-glutamic acid (glutamate) and is considered to be largely responsible for tea's flavour. It constitutes between 1% and 2% of the dry weight of green tea leaves. It is understood that the GABA binding properties of theanine can create a feeling of relaxation.

Theobromine belongs to a class of alkaloid molecules known as methylxanthines. Methylxanthines naturally occur in as many as sixty different plant species and include caffeine (the primary methlyxanthine in coffee) and theophylline (the primary methylxanthine in tea). Theobromine affects humans similarly to caffeine, but on a much smaller scale. Theobromine is mildly diuretic, is a mild stimulant, and relaxes the smooth muscles of the bronchi in the lungs.

Theophylline is a colourless crystalline alkaloid used in medicine as a bronchial dilator and found in very small amounts in tea. It has a stronger affect on the heart and breathing than caffeine. It is a cardiac stimulant, smooth muscle relaxant, diuretic and vasodilator.

The tea beverage can conveniently be prepared by brewing a given amount of tea leaves, such as in a tea bag or as added to a pot, in a volume of water that may correspond to the desired number of cups to be poured. The preparation involves a steeping process which, aside from extracting desirable tea flavour components, also extracts tannins into the brew. The more extended the brewing time the stronger and bitterer the brew becomes, due to increasing tannin extraction. Further, because of the particular flavour profile of tea, such increased tannins become harder to mask and thus more detectable to the consumer.

Attempts have been made in the art to simplify or expedite the tea brewing procedure. For example, U.S. Pat. No. 4,061,793 discloses a method for brewing a beverage such as coffee (but does mention tea). A preselected quantity of coffee grounds are retained under a mesh or web that is housed in a filter to be positioned over a cup. A single cup of coffee can be made by adding water into the filter which slowly (for at least 2-3 minutes) drains through the mesh and filter. The arrangement is concerned with producing a standard strength beverage of a standard cup volume.

JP 02-071713 discloses a “Tea Extractor” device for expediting the production of a tea “extract” and is directed to the design of the extractor, rather than the tea making procedure or the resulting extract produced.

U.S. Pat. No. 5,245,914 is concerned with a brewer apparatus that produces a steeped extract for making an iced tea (ie. the extract is to be diluted ¼ with cool water ¾). Because the extract is to be diluted, the apparatus of this document is not concerned with the making of a non-tannic tea concentrate; rather the emphasis is on the end product and not on the intermediate extract.

U.S. Pat. No. 6,182,555 discloses apparatus for steeping tea to produce a “single serving” using a dry and water soluble powdered (ie. instant) tea, held prior to use in storage bins. Because of the high surface area of a powder, steeping would extract a significant amount of tannins into the resultant beverage. To produce a standard strength tea beverage the powder amount would thus need to be reduced to compensate for the extra tannins extracted, reducing the amount of more desirable (eg. flavour) components extracted. Also, because the single serving is to be diluted, the apparatus of this document is not directed to the making of a non-tannic tea concentrate.

Attempts have also been made in the art to produce a tea extract that is akin in flavour strength and volume to a coffee espresso shot (ie. a small volume of liquid having a concentrated flavour). However, the problem of excessive tannin levels inevitably arises in such extracts, thus producing a bitter and somewhat unpalatable beverage.

For example, U.S. Pat. No. 2,688,911 is concerned with an espresso machine for the preparation of coffee, tea etc. In this document water is forced under pressure through a standard enclosed (confined) coffee filter unit 41 that is filled with coffee or the like. Whilst the apparatus may be suitable for coffee, tea leaves swell significantly when contacted with hot/boiling water (by around 60%). Thus, if unit 41 was filed with tea it would, as the tea swells under contact with the pressurised water in the confined space of unit 41, progressively reduce the flow of water through the tea material. Such filling would, in conjunction with the confined space, which is then subjected to pressurised water, result in significant tea steeping and extraction, inevitably producing a bitter tea extract. In addition, no tea making methodology per se is disclosed in U.S. Pat. No. 2,688,911.

U.S. Pat. No. 5,895,672 is directed solely to the use of tea “pods” to make a tea extract, in which tea leaves are enclosed within a filter paper pod containing a specified amount of tea The pod is shaped to fit tightly and compactly into an adaptor device. The adaptor device is designed so that pressurised water cannot flow around the edges of the pod but must flow through it. It is known that such pods do not function without pressurised water, as backpressure from the pod's filter paper tends to prevent unpressurised water from flowing through the pod. Again, because the tea is confined within the pod it swells significantly under contact with the hot pressurised water in the confined space, thereby progressively reducing the flow of water through the tea material. Because of pod filling and such swelling, in conjunction with the confined space and pressurised water, again a strong tea extract would also be bitter.

A reference herein to a prior art document is not an admission that the document forms part of the common general knowledge of a person of ordinary skill in the art in Australia or elsewhere.

### SUMMARY OF THE DISCLOSURE

In a first aspect there is disclosed a method of making an individual serving of an aqueous tea concentrate, the method comprising the steps of:

(a) locating at a strainer a quantity of loose particulate tea material that is sufficient to produce the individual tea concentrate serving;
(b) directly contacting the quantity of tea material with a sufficient amount of water so as to produce the individual tea concentrate serving, wherein each of the following parameters is controlled so as to minimise the extract of tannins from the tea material and into the concentrate:
the particle size of the tea material;
the tea material-water contact time;
the temperature of the water;
   (c) collecting the aqueous tea concentrate once it has passed through the strainer to thereby separate it from the particulate tea material.

The method according to the first aspect is able to produce an aqueous tea concentrate that has a strong and relatively non-bitter flavour, and which may be comparable in strength to that of a coffee extract made using an espresso machine. Because of its relatively non-bitter flavour the concentrate can be directly consumed as a beverage on its own. However, like a coffee espresso shot, it is also able to function as a base for a wide variety of beverage types, for example tea-type lattes, tea cappuccinos, tea frappes, long tea, long ice tea, etc (ie. to be diluted to form such beverages, and yet whilst retaining sufficient tea flavour without the associated tannic bitterness). Depending on the volume of aqueous concentrate produced, the individual serving of concentrate may also be able to be divided up into smaller multiple servings.

Whilst the aqueous tea concentrate may still comprise some level of tannins, when the concentrate is compared to a tea beverage made by conventional means, or made using known (eg. coffee-making) apparatus in a known way, the level of tannins in the concentrate is relatively low, such that they may either be non-detectable or not adversely noticeable to a user's taste.

The applicant has observed that a number of somewhat inter-related factors contribute to the production of a concentrate that has a strong yet relatively non-bitter flavour. In this regard, in addition to the parameters of tea material particle size and tea-water contact time, by directly contacting loose particulate tea material with water at a suitable temperature a strong and yet non-bitter tea concentrate can be produced.

Suitable control of these factors can also maximise the extract of tea flavour components, such as theanine, and can allow some other beneficial components (as outlined in the Background) to be preferentially extracted over tannins into the concentrate.

In relation to the tea material particle size, the tea material may comprise broken leaves, or ground leaves, or a combination thereof. If ground leaves are employed, they are typically ground to a size whereby an optimal water contact time is promoted.

The applicant has observed that in the method the time for producing the aqueous concentrate can increase with decreasing particle size of the tea material. However, if the tea material is ground too small (eg. to a powder) the particles can tend to agglomerate and tend to clog the strainer (especially where a fine filter needs to be employed to prevent powder flow therethrough). To fine a powder can thus result in excess steeping and excessive tannin extraction. Conversely, if the tea material is too large, the water can either flow too quickly through the leaves, or have insufficient leaf surface contact, resulting in a dilute brew. Thus, tea material particle size and contact time are interrelated and need to be controlled.

In one form, the particulate tea material used is fannings grade tea. An optimal fannings size can be between 18 to 24 mesh, as measured using the Tyler sieve series (i.e. 18 to 24 holes per square inch). The interstices that result in fannings grade tea that is loosely located at a strainer have been observed to provide for an optimal level of water flow through the tea material bulk and an optimal tea-water contact time.

For an individual (eg. one standard cup) serve of tea concentrate the weight of particulate tea material located at the strainer can be around 10 grams or less. The volume of water used and thus tea concentrate produced can be around 70 mls or less to produce a concentrate of around 40 mls or less.

A predetermined amount of suitable grade tea material that corresponds to the amount required for the individual serve of tea concentrate can be supplied in eg. a sachet or packet for ease of implementation of the method. In addition, an apparatus for dispensing boiling or near boiling water can be configured to dispense the required volume of water (eg. to produce a resultant tea concentrate shot of around 40 mls).

In relation to the tea material-water contact time for an individual (eg. one standard cup) serve of tea concentrate, a typical contact time is somewhere between 15 to 60 seconds, optimally around 20-30 seconds. In this regard, if the contact time is too short the water has insufficient time to extract tea flavour components and produces a dilute brew. If too long, the water tends to steep the tea, resulting in an excessive extraction of tannins.

Whilst the contact time may be varied with the particle size of the tea material, the contact time may also need to be varied with the type of tea material (eg. black and oolong tea versus green and white teas).

Further, the contact time can be optimised by regulating the water flow through the tea material bulk. Aside from tea particle size, this flow can in part be controlled by the flow rate through the strainer. When a mesh strainer is employed an optimal mesh aperture size for a fannings grade tea has been observed to be around 2 mm.

Typically the water is at atmospheric pressure, as pressurised water may be forced too quickly through the tea material at the strainer. The espresso machines that are used in the prior art to produce a tea beverage make use of pressurised water in apparatus for coffee-making, therefore being unsuitable in that form for the production of a strong yet non-tannic tea concentrate.

In relation to the water temperature, typically boiling or near boiling water is employed to directly contact the tea material located at the strainer. In this specification the terminology “near boiling water” means water that is at a temperature of approximately 95° C. or greater. It has been observed when contacting the tea material with water temperatures that are noticeably less than 95° C. that insufficient extraction of tea flavour components results and a dilute brew is produced. Also, for lesser temperature waters excessive contact time can be required, resulting in too much tea particle swelling, leading to steeping and too much tannin extraction.

In this specification the terminology “loose” in relation to the particulate tea material indicates that the tea material is not firmly or tightly held in place, and not compacted to any appreciable extent.

In this regard, in step (a) a mass may be located on the loose particulate tea material so as to restrict the upward expansion of the loose particulate tea material as it is directly contacted with the water. In one form the mass may be a disc. The mass may have one or a number of apertures therethrough. However, the mass is selected so as not to compact and thus hinder or restrict water flow through the tea material bulk.

The water may be passed through a diffuser prior to step (b) so as to maximise the distribution of the water onto and over the particulate tea material. In this way, the diffuser can spread the water so as to provide for a more even contact and wetting of the tea material bulk. In one form, the mass can function as the diffuser when it is provided with a number of apertures therethrough.

In one form the strainer may comprise a frusto-conical hollow body into which the loose particulate tea material can be located. A filtration mesh can be disposed at a narrow end of the body, with the loose particulate tea material being disposed adjacent to the mesh in use. The mass may be mechanically associated with the strainer so as to be selectively deployed after locating the loose particulate tea material at the strainer.

In a variation, the method may include the additional step of adding one or more flavouring substances to the loose particulate tea material prior to step (b) and/or to the aqueous concentrate. The flavouring substances can comprise sweeteners, herbs, spices or the like.

In a second aspect, there is disclosed apparatus for making a tea concentrate, the apparatus comprising:

(a) a strainer at which a quantity of loose particulate tea material can be located for contact with water so as to produce an aqueous concentrate that is separated at the strainer from the tea material; and

(b) a mass that is locatable on the loose particulate tea material so as to restrain the upward expansion of the loose particulate tea material when it is directly contacted with the water.

In one form the mass may be a disc (eg. of stainless steel). The mass may have one or a number of apertures therethrough.

In one form, when the mass has a number of apertures therethrough, it can function as a diffuser to maximise the distribution of water onto the particulate tea material. In this way, the mass can spread the water over the tea material to provide for a more even contact of the entire bulk of tea material.

In one form the strainer may comprise a frusto-conical hollow body into which the loose particulate tea material can be located. A filtration mesh can be disposed at a narrow end of the body, with the loose particulate tea material being disposed adjacent to the mesh in use. When fannings grade tea is used, an optimal mesh aperture size has been found to be around 2 mm to promote an optimal flow rate through the strainer, and thus an optimal tea-water contact time. The mesh size may also be adjusted to the grade of tea material to maintain a flow rate through the strainer that provides an optimal tea-water contact time.

The strainer may also be adapted for being coupled into an existing hot water dispensing apparatus, such as at an espresso machine outlet. However, typically the strainer is also configured such that an air space is provided above the tea material when located therein to allow for tea material expansion in use.

In one form the mass may be mechanically associated with the strainer so as to be selectively deployed after locating the loose particulate tea material at the strainer. In this regard, the mass can be connected to the strainer via a flexible or rigid connector. The rigid connector can be connected to the strainer to enable the mass to pivot between a non-deployed position in which it does not interfere with tea material location at the strainer, and a deployed position in which it restrains the upward expansion of the loose particulate tea material.

When the mass is disc-like the connector can be elongate to extend integrally from the disc. In one form it can be pivotally mounted to the strainer at an opposite end to where it is connected to the disc. Alternatively, the elongate connector can be in the form of and can function as a handle to enable manual deployment of the mass.

In a third aspect, there is disclosed a tea concentrate produced by the method or apparatus as defined in the first and second aspects.

In a fourth aspect, there is disclosed a kit for making a tea concentrate, the kit comprising the apparatus as set forth in the second aspect together with at least one of a measure of particulate tea material to produce the individual serving of tea concentrate in accordance with the method of the first aspect, or a receptacle for collecting the tea concentrate once it has passed through the strainer.

Such a kit can enable a consumer to conveniently make the tea concentrate when desired, at any time of the day, for example at home, at work, when entertaining etc.

In the kit the at least one measure of particulate tea material may be held in at least one corresponding packet or sachet. A plurality of such packets or sachets can be provided in the kit. The kit may also comprise a plurality of packets or sachets holding other additives such as sweeteners, herbs, spices or the like. Alternatively, the at least one measure of particulate tea material may be provided by a measuring device such as a scoop or spoon of predetermined capacity.

The kit may comprise more than one receptacle, and the (or each) receptacle may comprise a cup or glass having at least sufficient volume to hold the tea concentrate. However, the cup or glass may have sufficient volume to subsequently enable the making therein of a beverage such as a tea-type latte, cappuccino, long tea etc. The receptacle can also be sized to optimally cooperate with the strainer.

### BRIEF DESCRIPTION OF THE DRAWINGS

Notwithstanding any other forms that may be embraced by the method, apparatus, tea concentrate and kit as set forth in the Summary, specific embodiments will now be described, by way of example only, with reference to the accompanying drawings in which:

FIG. 1 shows a schematic process flow diagram of an embodiment of a method of making a tea concentrate, and including a number of optional steps.

FIG. 2 shows a front perspective view of a first embodiment of apparatus for malting a tea concentrate.

FIGS. 3A and 3B show front perspective views of second and third embodiments of apparatus for making a tea concentrate.

FIG. 4 shows a front perspective view of a fourth embodiment of apparatus for making a tea concentrate.

FIG. 5 shows a front perspective view of a first embodiment of a kit for making a tea concentrate.

FIG. 6 shows a front perspective view of a second embodiment of a kit for making a tea concentrate.

### DETAILED DESCRIPTION OF SPECIFIC EMBODIMENTS

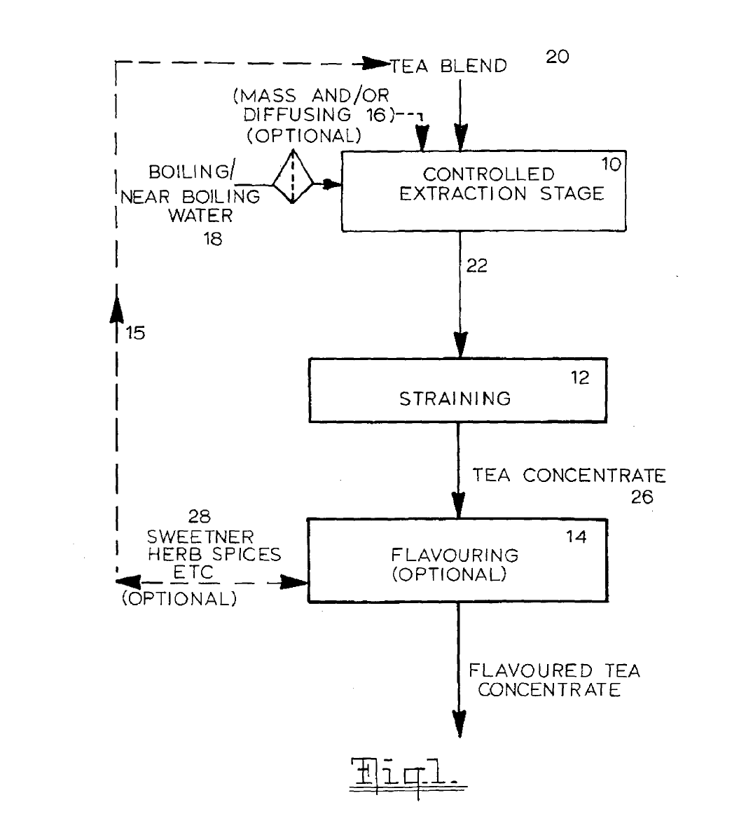

Referring firstly to FIG. 1 the method steps for making a tea concentrate are schematically depicted in a type of flowsheet. The method can produce a tea concentrate of about 30-40 mls for consumption by one person. The concentrate can be consumed directly as an individual serving, or can be either immediately or subsequently added to and blended with a desired medium, ranging from hot or cold milk, espresso (steam-heated) milk, hot or cold water, ice, etc. Using the method a variety of beverages can be formed including lattes, cappuccinos, frappes, long iced tea and the like.

The method comprises two core steps, a direct contacting step and a separating step, around which other optional steps can be added as desired. The contacting step is shown in FIG. 1 as a controlled extraction stage 10, whilst the separating step is shown as straining 12. The optional steps illustrated in FIG. 1 are that of mass/diffusing 16 and flavouring 14.

During the extraction stage, boiling or near boiling water 18 is brought into direct contact with a quantity of loose particulate tea material, shown in FIG. 1 generically as a tea blend 20. The term “near boiling” is intended to describe water having a temperature between approximately 95 to 100° C. when it contacts the tea material. Water available from some espresso machine outlets may be in this range.

The applicant has surprisingly discovered that by directly contacting certain grades of loose particulate tea material with boiling or near boiling water for a controlled time period a strong tea concentrate can be produced with minimal or significantly reduced extraction of tannins. As the boiling or near boiling water 18 flows though the interstices between the tea blend, tea flavour components (such as theanine etc) are released (or gently leached) into the water from the tea leaves, thereby producing an aqueous tea concentrate 22 that is separate to the remaining tea material residue with retained tannins. The aqueous concentrate is strained 12 where the resultant tea concentrate 26 can be used directly or stored for later use or further processing.

In the method the tea blend is typically located immediately adjacent to a strainer such as a conical or other filter apparatus (as described below), so that straining 12 takes place almost immediately once the water has passed through the tea material bulk in stage 10.

FIG. 1 also illustrates an optional method step in the form of flavouring step 14, where various flavouring substances such as sweetners, herbs and spices etc 28 can be added to the concentrate 26 to accommodate any desired taste. As an alternative, these sweeteners, herbs, spices, etc., may be added in with the tea blend for extraction/dissolution into the aqueous concentrate 22, as indicated by the dotted arrow 15 in FIG. 1.

The time and temperature of the extraction process can be varied to accommodate the particularities of the particulate tea material being used. Factors such as the particle size of the material being used in the tea blend, the type of material, (i.e. leaf, flower or other plant material) and the species of material (tea bush, rose petals, masala etc) can influence the way in which the method is implemented and the resulting concentrate that is produced. The method can accommodate these factors by varying the particle size of the tea material and the tea-water contact time in the extraction stage 10.

For example, if 10 grams of pekoe fannings are used as the tea blend with a particle size of between 18 to 20 mesh (Tyler sieve) the extraction time may be less than the extraction time needed when 10 grams of orange fannings are used with a particle size of between 20 to 22 mesh. The particulate size of the material can effect back pressure to water flow that occurs within the interstices of the loose particulate tea material.

The back pressure can also be affected by the expansion and buoyancy effects of the loose particulate tea material as it becomes wetted. Thus, FIG. 1 also illustrates an optional method step in the form of the introduction of a mass, as well as or an alternative diffusing step 16.

By locating a mass on the particulate material bulk located at the strainer the upward expansion of loose particulate tea material can be restrained when it is directly contacted by boiling/near boiling water.

By diffusing the boiling/near boiling water over the particulate material bulk located at the strainer, a more even wetting and a more controlled extraction of the tea can be achieved. The mass located on the particulate material bulk can also provide a diffusing function, as described below. In any case, the diffuser is selected and located so that a suitable temperature of water to contact the tea material is maintained.

The mass can be sourced from a wide range of forms, with the mass comprising an element of a suitable weight and shape so as not to unduly compress the loose particulate tea material and thereby overly slow water flow therethrough. It has been found that a disc-like element (eg. a washer of stainless steel) having one or more apertures therethrough can provide an appropriate mass.

The diffuser can be a mesh or other perforated water distribution device.

The tea blend may include a variety of loose particulate tea materials, such as dried and/or prepared leaves of Camellia sinensis, or any kind of leaves, flowers etc of other plants that are capable of releasing an aqueous extract when contacted with water so as to produce a consumable tea-like concentrate (eg. leaves, flowers etc of peppermint, spearmint, chamomile, hibiscus, rosehip etc). Typically the particulate tea material comprises broken leaves or ground leaves or a combination thereof.

In one example employing the methodology of FIG. 1 pekoe fannings were used, however, other suitable examples of broken leaves included orange fannings and broken orange pekoe fannings. These fanning examples roughly correlate to grades of tea leaf, which are generally determined by the size of tea leaf. Blends of these and other tea grades can be used in the method, so as provide a tea concentrate that is intended for a particular geographic market, or blending apparatus, or consumer demographic for which the tea concentrate is intended for sale.

For example, it is possible to use the method to produce a tea concentrate using fannings from Darjeeling, Assam, Nilgiri, Sri Lanka and green tea. When distributing the particulate tea material in a sachet, packet or other measured receptacle, the tea material can be mixed with spices, such as cinnamon, cardamon, ginger, cloves etc. Alternatively the particulate tea material itself can be flavoured with an essence as part of its preparation (an essential edible oil).

The method allows a user (eg. a barista) to pre-prepare the tea concentrate as a single serve or as a serve to be subsequently divided. The tea blend can be supplied to the user in single serving quantities, such as in a sachet or packet, or can be dispensed by a user using a measuring device from bulk containers as a premixed blend, or may be blended on site. Usually for a single serving a quantity of approximately 8 to 10 grams of the tea blend is generally suitable for producing a “shot” volume of tea concentrate of about 40 mls. However more or less of the tea blend can be added to accommodate an individual's taste preference.

It is also intended that the method does allow a user to make a large batch of tea concentrate, which can be considered as an “individual serving”, which serving can then be divided into smaller multiple servings. Such batches can also be pre-made for later use.

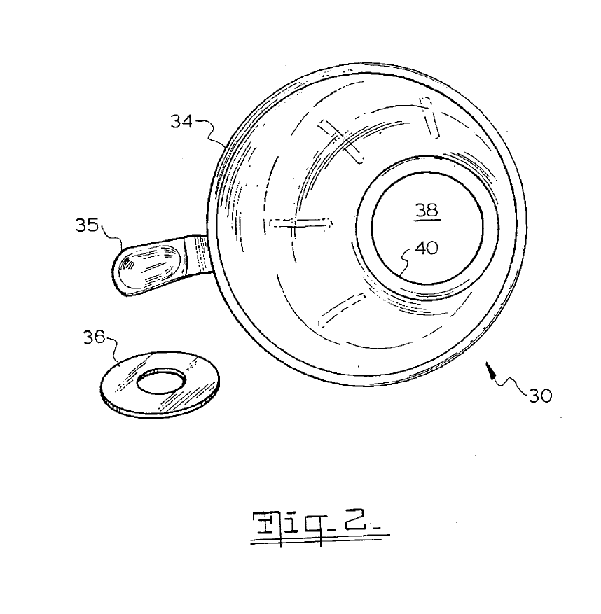

Referring now to FIGS. 2 to 4 several embodiments of an apparatus for malting a tea concentrate are depicted and will now be described, noting that similar or like parts are numbered with like numerals.

Each apparatus of FIGS. 2 to 4 can be used to implement the method of making the tea concentrate as outlined herein. The apparatus can comprise a strainer in the form of a filtration assembly. The filtration assembly can in turn assume many forms including a simply supported filter paper, however, is conveniently of a form that is robust and in use can sit within and be self-supported at a desired receptacle (such as a cup) for the tea concentrate.

In each of FIGS. 2 to 4 a form of the filtration assembly 30 comprises a frusto-conical hollow body 34 that is constructed from a suitable food-grade material (eg. stainless steel). A fine woven metal (eg. stainless steel) mesh 38 is mounted at a narrow end 40 of the body 34. To facilitate handling when the body 34 becomes heated, the body is provided with a laterally projecting handle 35.

The filtration assembly can be used in conjunction with a mass as previously described. For example, in FIG. 2, the mass is shown in the form of a washer 36 positionable on tea material located in the body 34 in use.

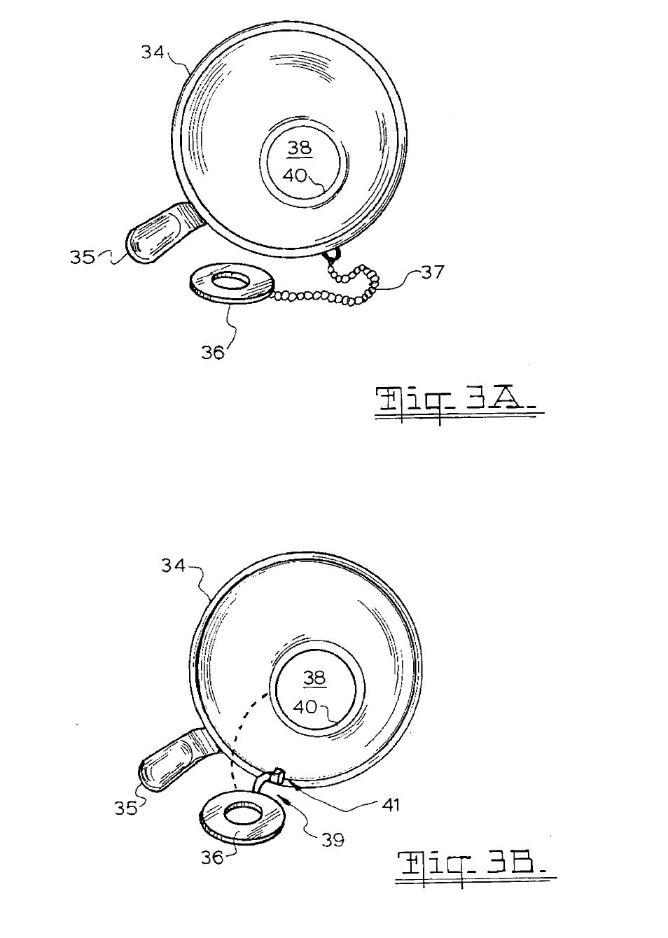

In FIG. 3A the washer 36 is shown connected to the body 34 by way of a chain 37. In FIG. 3B the washer 36 is shown as being pivotally connected to the body 34 by way of a curved elongate arm 39. The arm 39 extends integrally from the washer and is pivotally connected at an opposite end to a lug 41 located at the body. The washer can thus be moved or pivoted between the non-deployed position as shown and, after locating tea material in the body 34, a deployed position in which the washer can be positioned on the tea material. The pivoting action is indicated by a dotted line in FIG. 3B. By connecting the washer to the body 34, the washer is less likely to be accidentally disposed of when the wetted spent tea blend is disposed of, or when washing the filtration assembly 30 after use.

In FIG. 4, the mass is shown in the form of a disc 36A that comprises an integral handle 42 to facilitate disc positioning on tea material located in the body 34 in use. The disc 36A comprises a plurality of apertures 44 therethrough so that it can also act to diffuse the flow of hot water over the tea material located in the body 34 in use. The disc may also have an increased diameter to closely match the inside diameter of body 34 when positioned therein one the tea material in use, to further aid in its suitable location, and to aid in enhanced water diffusion.

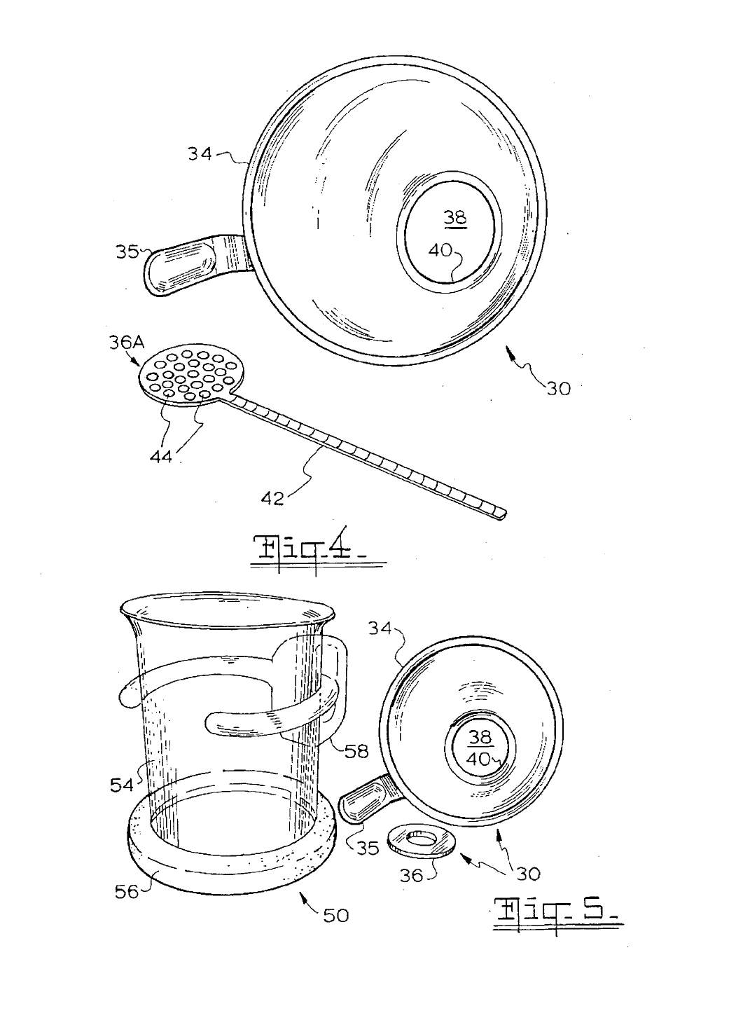

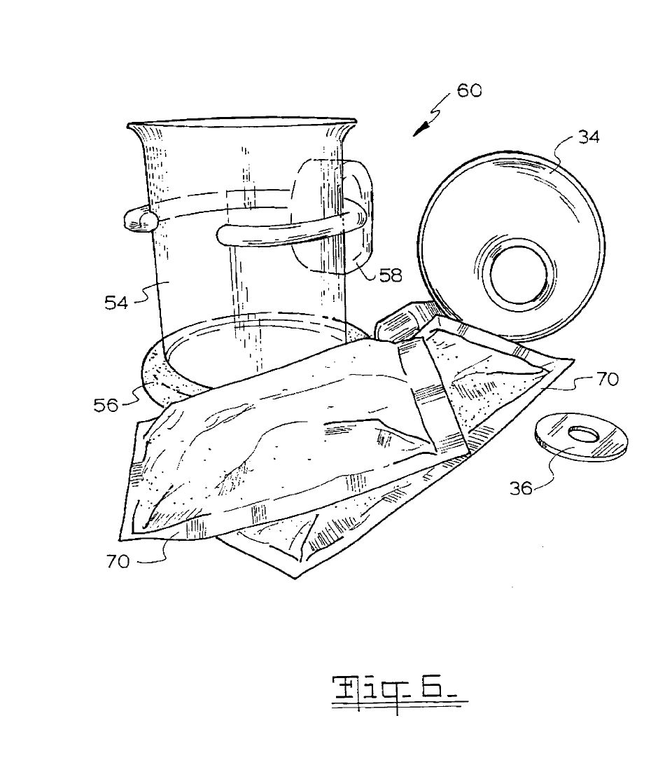

Referring now to FIG. 5, a first kit embodiment 50 is shown that includes the filtration assembly 30 and washer 36 of FIG. 2, together with a receptacle in the form of a glass cup 54 having a dedicated cork coaster 56 and handle 58. The filtration assembly 30 and glass cup 54 are optimally sized for use together.

In FIG. 6, an alternative kit 60 is illustrated. Again the kit includes the filtration assembly 30 and washer 36 of FIG. 2. However, instead of or in addition to the glass cup 54, coaster 56 and handle 58, the kit 60 can include one or more prepacked sachets 70, each containing a measured quantity of a desired optimal grade tea blend for use in the assembly 30. The measured amount is designed to provide an optimum dose for the particular kit components so as to produce a suitable strong and non-bitter tea concentrate.

The kits 50, 60 can be formed from any of the washer/disc configurations of FIGS. 2 to 4. The kits 50, 60 can be supplied in a container, packet/package, bag, box etc. The kits 50, 60 may further include instructions for the carrying out of the method as well as recipes for various tea-blends. Also sachets containing other ingredients (eg. sweeteners, herbs, spices etc) for blending can be supplied in the kits.

The kits 50, 60 also allow a user to prepare a desired tea beverage at any convenient time and place, for example at home or at work. A first time user can purchase a complete kit and thereafter only needs to purchase the tea blend sachets when existing sachets are exhausted. The tea blend sachets can thus be supplied separately and with the kit, for example in the form of mixed individual sachets of differing blends. Tea blends may also be supplied in bulk (i.e. in a tin, container, packet, package etc) and including a suitable measuring device such as a scoop or spoon.

In use of the apparatus and kits, a predetermined quantity of an optimal grade tea blend is located inside the body 34, resting upon the mesh screen 38, the body in turn resting on the glass cup 54. The washer 36 or disc 36A is placed on top of the tea blend. The tea blend is then wetted with a predetermined volume of boiling/near boiling water which diffuses over the washer/disc and flows through the tea blend bulk. The water then flows through the mesh screen 38 and into glass cup 54 as a tea concentrate.

The apparatus and kits are typically configured so that a user merely needs to ensure that a correct volume of water is provided into the body 34. Where a user is pouring from eg. a kettle (and not a controllable water dispensing apparatus) the body 34 can be provided with clearly discernible internal markings to indicate volume. The kit instructions can then provide guidance on a suitable volume for a given tea blend and for a given desired strength of tea concentrate.

Whilst a mass in the form of a washer or disc can be provided in the kit for convenience, whether or not the mass is used can depend on a number of factors, These can include the type of receptacle, the type of tea blend, and the form of the filtration apparatus used. In FIGS. 2 to 4 the mass is disclosed as a washer 36 or disc 36A. However, as previously described, the mass may assume many forms and accordingly the mass may be incorporated into the filtration assembly. In other examples, the mass may comprise a flat, un-apertured disc or plate, a ball or block (eg. of metal or ceramic), a fine mesh screen that also functions as a diffuser etc.

### EXAMPLES

Non-limiting examples of the methodologies described above will now be provided.

### Example 1

A trial was carried out using 9 grams of pekoe fannings having a broken leaf size of between 20 to 24 mesh, as measured using the Tyler sieve series (i.e. 20 to 24 holes per square inch), to determine the quality of the tea concentrate when using boiling water. The pekoe fannings were placed in a frusto-conical filter having a very fine mesh and having a restricted outlet. Boiling water was prepared, using a kettle, and approximately 70 mls was poured directly onto the pekoe fannings with an extraction time of 20-25 seconds. The resultant permeate produced passed through the filter and was thus separated from the pekoe fannings to provide about 30 mls of a tea concentrate in its final form. The tea concentrate produced by this method had a strong flavour and did not have a strong tannin bitterness.

### Example 2

A trial was carried out using 10 grams of pekoe fannings having a broken leaf size of between 20 to 24 mesh, as measured using the Tyler sieve series, to determine the quality of the tea concentrate when using near boiling water sourced from an espresso machine. The pekoe fannings were first ground to reduce their size and then placed in a conical filter having a very fine mesh and having a restricted outlet. Near boiling water was sourced in free flow from the hot water outlet of the espresso machine. Approximately 40 mls of near boiling water was poured directly onto the pekoe fannings to allow an extraction time of 25-30 seconds. The resultant permeate produced passed through the filter where it was separated from the pekoe fannings to provide the tea concentrate in its final form. The tea concentrate produced by this method had a strong flavour and did not have a strong tannin bitterness.

### Example 3

A trial was carried out using 10 grams of leaf blend of orange fannings and rose petals having a broken leaf size of between 18 to 20 mesh, as measured using the Tyler sieve series, to determine the quality of the tea concentrate when using a leaf blend. The leaf blend was placed in a conical filter having a very fine mesh and having a restricted outlet. In a similar manner to Example 1, boiling water was prepared using a kettle. Approximately 70 mls of boiling water was poured directly onto the leaf blend with an extraction time of 30-40 seconds. The resultant permeate produced passed through the filter where it was separated from the leaf blend to provide about 40 mls of the tea concentrate in its final form. Again, the tea concentrate produced by this method had a strong flavour and did not have a strong tannin bitterness.

### Example 4

A trial was carried out using 90 grams of pekoe fannings having a broken leaf size of between 20 to 24 mesh, as measured using the Tyler sieve series, to determine the quality of the tea concentrate when making concentrate that could subsequently be divided into multiple servings. The pekoe fannings were placed in a conical filter having a larger mesh than used for Examples 1 to 3 and having a restricted outlet. As previously, boiling water was prepared, using a kettle. To distribute the boiling water evenly over the pekoe fannings, the water was first passed through a diffuser, in the form of a course filter located at the tea material, and approximately 300 mls was caused to flow directly onto the pekoe fannings. An extraction time of 100 seconds was allowed. The resultant permeate produced was then separated from the pekoe fannings to provide the tea concentrate in its final form. Once again, the tea concentrate had a strong flavour and did not have a strong tannin bitterness.

### Example 5

A trial was carried out using 10 grams of green tea ground on a electric coffee grinder, a Breville (trade mark of Housewares International Limited) model CG10, at No. 4 setting. The ground green tea was placed in a conical filter having a fine mesh and having a restricted outlet. As previously, boiling water was prepared using a kettle. Approximately 70 mls was poured directly onto the ground green tea. An extraction time of 30 seconds was allowed. The resultant permeate produced was then separated from the ground green tea to provide about 40 mls of the tea concentrate in its final form. The tea concentrate had a strong flavour and did not have a strong tannin bitterness.

### Example 6

A trial was carried out using 10 grams of green tea ground on the Breville electric coffee grinder, model CG10, at No. 9 setting to produce a coarser ground tea material than that used in Example 5. Like Example 5, the ground green tea was placed in a conical filter having a fine mesh and having a restricted outlet. As previously, boiling water was prepared using a kettle. Approximately 70 mls was poured directly onto the ground green tea. An extraction time of 25 seconds was allowed. The resultant permeate produced was then separated from the ground green tea to provide about 40 mls of the tea concentrate in its final form. The tea concentrate had a strong flavour and did not have a strong tannin bitterness.

### Example 7

A trial was carried out using 8 grams of leaf blend of masala chai having a broken leaf size of between 18 to 20 mesh, as measured using the Tyler sieve series, to determine the quality of the tea concentrate when using a leaf blend. The leaf blend was placed in a frusto-conical filter having a very fine mesh and having a restricted outlet. An 8 mm washer was place on top of the leaf blend. Like Example 1, boiling water was prepared, using a kettle. Approximately 35 mls of boiling water was poured directly onto the leaf blend twice to allow an overall extraction time of 30-40 seconds. The wetted leaf blend expanded as the water was taken up, whereby the mass of the 8 mm washer acted as a counterweight and restrained expansion of a significant portion of the wetted leaf blend. The resultant permeate produced passed through the filter where it was separated from the leaf blend to provide the tea concentrate in its final form. The tea concentrate produced by this method had a strong flavour and did not have a strong tannin bitterness. Frothed milk was then added to make a chai latte having a smooth and pleasant flavour.

Using the methodology as described, a wide variety of tea beverages can be made in a short period of time. A single cup of regular tea can be produced in approximately a minute by taking 5 grams of fannings tea, pouring a measured amount of water slowly over the tea in a suitable strainer that empties into the cup to make a filtered tea concentrate and then filling the cup with boiling or near boiling water. Likewise, if a tea equivalent to a cappuccino is desired, a dark, stronger concentrate can be produced by pouring 70 mls of water over 10 grams of loose fannings in the strainer, then adding frothed, full cream or low fat milk (or soy milk) to the concentrate in the cup. Ice tea can be rapidly produced by taking 10 grams of tea, making a concentrate as generally previously described, pouring the concentrate into a jug and adding cold water, ice cubes, lemon and sweetener. Alternatively, iced milk tea can be made by adding the concentrate to cold milk with or without ice. Even a pot of tea can be made almost instantly by adding boiling water directly to a pre-made concentrate located in the pot.

The methodology thus provides a quick and efficient way of making strong tea concentrates without accompanying tannic bitterness. The method allows a retail shop to make many different types of extract flavour at the same time, one after another. An entire order can be produced upon request. For example, using the methodology a shop can easily produce a variety of tea types such as marsala chai latte, Assam chai cappuccino, Ceylon chai frappe, Darjeeling iced tea, Nilgiri cold milk beverage, green tea marsala latte, organic green tea frappe etc.

By making fresh tea concentrate for each serving, deterioration of beverage or variability of beverage quality can be avoided. Furthermore, individual serves can be made without the need to use teabags, thereby reducing waste. Again, the methodology provides a simple and convenient way for a retail outlet or business to produce and sell a wide range of tea beverages, tailor the range of tea beverages according to customer tastes, and to accommodate demand.

The methodology may also be adapted to be used with existing equipment, such as an espresso machine or a boiling water dispenser, to make the tea concentrate.

Whilst a number of embodiments of the method, apparatus, kit and resulting tea concentrates have been described, it will be appreciated that these can be embodied in many other forms.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments.

1. A method of making an individual serving of an aqueous tea concentrate, the method comprising the steps of:
(a) locating at a strainer a quantity of loose particulate tea material that is sufficient to produce the individual tea concentrate serving;
(b) directly contacting the quantity of tea material with a sufficient amount of water so as to produce the individual tea concentrate serving, wherein each of the following parameters is controlled so as to minimise the extract of tannins from the tea material and into the concentrate:
the particle size of the tea material;
the tea material-water contact time;
the temperature of the water;
(c) collecting the aqueous tea concentrate once it has passed through the strainer to thereby separate it from the particulate tea material.

2. A method as claimed in claim 1, wherein the particulate tea material comprises broken leaves, ground leaves, or a combination thereof.

3. A method as claimed in claim 1, wherein the particulate tea material comprises fannings grade tea.

4. A method as claimed in claim 1, wherein the fannings size is in between 18 to 24 mesh, as measured using the Tyler sieve series.

5. A method as claimed in claim 1, wherein the tea material-water contact time ranges from 15 to 60 seconds.

6. A method as claimed in claim 5, wherein the tea material-water contact time ranges from 20-30 seconds.

7. A method as claimed in claim 1, wherein the tea material-water contact time is varied with the particle size of the tea material and/or with the type of tea material.

8. A method as claimed in claim 1, wherein the tea material-water contact time is optimised by regulating the water flow through the tea material bulk by controlling the flow rate through the strainer.

9. A method as claimed in claim 8, wherein the strainer is a mesh strainer having a mesh aperture size of around 2 mm for a fannings grade tea.

10. A method as claimed in claim 1, wherein the water temperature is at boiling or near boiling.

11. A method as claimed in claim 1, wherein the water is at atmospheric pressure.

12. A method as claimed in claim 1, wherein step (a) comprises locating a mass on the loose particulate tea material so as to restrict the upward expansion of the tea material as it is contacted with water.

13. A method as claimed in claim 1, wherein the water is passed through a diffuser prior to step (b) so as to distribute the water onto the particulate tea material.

14. A method as claimed in claim 1, wherein the strainer comprises a frusto-conical body, with a filtration mesh disposed at a narrow end of the body, and wherein the loose particulate tea material is disposed adjacent to the mesh in use.

15. A method as claimed in claim 1 further comprising the step of adding one or more flavouring substances to the tea material prior and/or subsequent to step (b).

16. Apparatus for making a tea concentrate, the apparatus comprising:
(a) a strainer at which a quantity of loose particulate tea material can be located for contact with water so as to produce an aqueous concentrate that is separated at the strainer from the tea material; and
(b) a mass that is locatable on the loose particulate tea material so as to restrain the upward expansion of the loose particulate tea material when it is directly contacted with the water.

17. Apparatus as claimed in claim 16, wherein the mass is a disc having one or more apertures therethrough.

18. Apparatus as claimed in claim 16, wherein the mass is connected to the strainer via a flexible or rigid connector, or is detached from the strainer but has an elongate handle extending therefrom.

19. Apparatus as claimed in claim 18, wherein the rigid connector is connected to the strainer to enable the mass to pivot between a non-deployed position in which it does not interfere with tea material location at the strainer, and a deployed position in which it restrains the upward expansion of the loose particulate tea material.

20. Apparatus as claimed in claim 16, wherein the strainer comprises a frusto-conical hollow body into which the loose particulate tea material can be located, with a filtration mesh being disposed at a narrow end of the body, whereby the loose particulate tea material can be disposed adjacent to the mesh in use.

21. Apparatus as claimed in claim 20, wherein the mesh aperture size is around 2 mm.

22. (canceled)

23. A kit for making a tea concentrate, the kit comprising the apparatus as set forth in claim 16 together with at least one of:
a measure of particulate tea material to produce an individual serving of tea concentrate in accordance with the method of claim 1; or
a receptacle for collecting the tea concentrate once it has passed through the strainer.

24. A kit as claimed in claim 23, wherein the at least one measure of particulate tea material is held in at least one corresponding packet or sachet, or is provided by a measuring device of predetermined capacity.

25. A kit as claimed in claim 23, wherein the receptacle comprises a cup or glass having at least sufficient volume to hold the tea concentrate.
